(19) United States
(12) Patent Application Publication
(10) Pub. No.: US 2009/0205620 A1
(43) Pub. Date: Aug. 20, 2009

(54) Pressure Control Valve, Crankcase Ventilation Device, and Method for the Operation Thereof

(75) Inventor: Wolfram ENKE, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/432,305

(22) Filed: Apr. 29, 2009

(30) Foreign Application Priority Data
Oct. 30, 2006 (DE) 10 2006 051 062.3
Sep. 8, 2007 (EP) PCT/EP2007/007853

(51) Int. Cl. F02B 25/06

(52) U.S. Cl. 123/574

(57) ABSTRACT

A pressure control valve is provided for a crankcase ventilator of an internal combustion engine. The pressure control valve includes a valve housing, a valve diaphragm, and a valve spring. A separate shutoff valve is provided for shutoff of the pressure control valve. A crankcase ventilation device includes such a pressure control valve. A method is provided for operating the crankcase ventilation having the pressure control valve.

### CROSS-REFERENCE TO RELATED APPLICATIONS

This application is a continuation of PCT International Application No. PCT/EP2007/007853, filed Sep. 8, 2007, which claims priority under 35 U.S.C. § 119 to German Patent Application No. 10 2006 051 062.3, filed Oct. 30, 2006, the entire disclosures of which are herein expressly incorporated by reference.

### BACKGROUND AND SUMMARY OF THE INVENTION

The invention relates to a pressure control valve for a crankcase ventilator of an internal combustion engine, including a valve housing, a valve diaphragm, and a valve spring. The invention further relates to a crankcase ventilation device, including a pressure control valve of this type, and a method for operating the pressure control valve or the crankcase ventilation device.

During the operation of internal combustion engines, gases (blow by gases) may escape into the crankcase because of the lack of absolute tightness of the combustion chambers in the area of the piston rings. To prevent an excess pressure increase in the crankcase, crankcase ventilators are typically provided, via which a pressure equalization may occur, in that gases escape from the crankcase and may be recirculated back into the intake system of the internal combustion engine. Furthermore, situating a pressure control valve in the area between the crankcase and the intake system to regulate the exhaust stream of crankcase gases into the intake system is known.

For example, DE-OS 1 526 575 proceeds from a crankcase ventilation device of this type and describes a check valve situated upstream from the control valve on the intake system side. The check valve closes the connection to the crankcase in case of a misfire of the internal combustion engine because of the increased pressure in the intake system. A continuation of the pressure wave into the crankcase is prevented in this way.

The disclosed configuration appears expedient in connection with a hydrocarbon-operated, in particular gasoline-operated or diesel-operated internal combustion engine, but not if the internal combustion engine is gas-operated, in particular hydrogen-operated.

In gasoline-operated or diesel-operated internal combustion engines, in the event of misfires of the internal combustion engine, a flashback occurs originating from the cylinder inlet in the direction of the intake system, a pressure wave also propagating through the crankcase ventilator in the direction of the crankcase. The flame front of the flashback is extinguished relatively rapidly on the cylinder inlet side, because an ignitable gas mixture is not present in the intake system or in the crankcase. This is to be attributed in particular to the relatively narrow ignition limits of the fuel/air mixture.

The situation occurs completely differently in gas-operated, in particular hydrogen-operated, internal combustion engines. The fuel has a very high ignitability in broad ranges in connection with air, so that in case of a misfire of the internal combustion engine, a propagation of the flame front through the crankcase ventilator into the crankcase and the ignition of a greater quantity of ignitable mixture therein are possible.

A further aspect in connection with gas-operated internal combustion engines relates to the possible accumulation of fuel (vapors) in the intake system, in particular when the internal combustion engine is not in operation, with the result of a very high probability of ignition upon the following startup of the internal combustion engine. An accumulation of fuel in the intake system of this type may result from an increased quantity of blow by gases or a defect in the fuel supply, for example.

The object of the invention is to effectively prevent the ignition of a flammable fuel/air mixture in the intake system and/or a flashback via the crankcase ventilator into the crankcase starting from the cylinder inlet of a hydrogen-operated internal combustion engine in particular. In case of a misfire of the internal combustion engine, the propagation of the flame front through the crankcase ventilator into the crankcase is to be prevented. Alternatively or additionally, the possibility of accumulation of fuel in the intake system is already to be avoided. In particular, the ventilation volume flow of the crankcase ventilation device during operation of the internal combustion engine is concurrently not to be impaired.

According to the invention, a pressure control valve is provided having a separate shutoff valve for shutting off the pressure control valve. A crankcase ventilation device is provided having a partial vacuum pump for evacuating the separate chamber. A method is provided wherein the pressure control valve is closed if the flashover of a combustible mixture in the crankcase is to be prevented.

Especially advantageous embodiments and refinements are described and claimed herein.

According to a preferred embodiment of the invention, the shutoff valve blocks the pressure control valve in a non-actuated preferential position and releases it in an actuated position. A high operational reliability is achieved in this way, as the pressure control valve is blocked in the event of a possible system breakdown. In addition, energy is only required when the pressure control valve is opened.

An especially high operational reliability is insured in that the shutoff valve expediently includes a shutoff membrane and a shutoff spring, which spring works together with the valve membrane. Thus, the switching element of the pressure control valve may be blocked directly.

According to an especially preferred exemplary embodiment of the invention, the shutoff valve is situated in the valve housing, a separate chamber, which may be evacuated, being formed between shutoff diaphragm and valve housing.

Providing a partial vacuum pump to evacuate the separate chamber and using an electric changeover valve, which may be powered to switch the partial vacuum pump, has proven itself in a crankcase ventilation device having a pressure control valve according to the invention. The separate chamber is not evacuated if the electric changeover valve is not powered and the separate chamber is evacuated if the electric changeover valve is powered.

In a crankcase ventilation device having multiple pressure control valves, a shared partial vacuum pump is preferably provided for evacuating the separate chambers of the pressure control valves.

An especially preferred method for actuating a pressure control valve according to the invention or a crankcase ventilation device having a pressure control valve according to the invention is distinguished in that the pressure control valve is closed if a flashover of a combustible mixture is to be prevented in the crankcase. This is particularly the case if the internal combustion engine is shut down or during the starting phase of the internal combustion engine.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram of a crankcase ventilation device having shutoff valves actuated by partial vacuum, a partial vacuum pump, and an electric changeover valve;

FIG. 2 is a sectional view of a shutoff valve, actuated by partial vacuum, for a crankcase ventilator; and

FIG. 3 is a diagram of an intake system of an internal combustion engine having a shutoff valve actuated by partial vacuum.

### DETAILED DESCRIPTION OF THE DRAWINGS

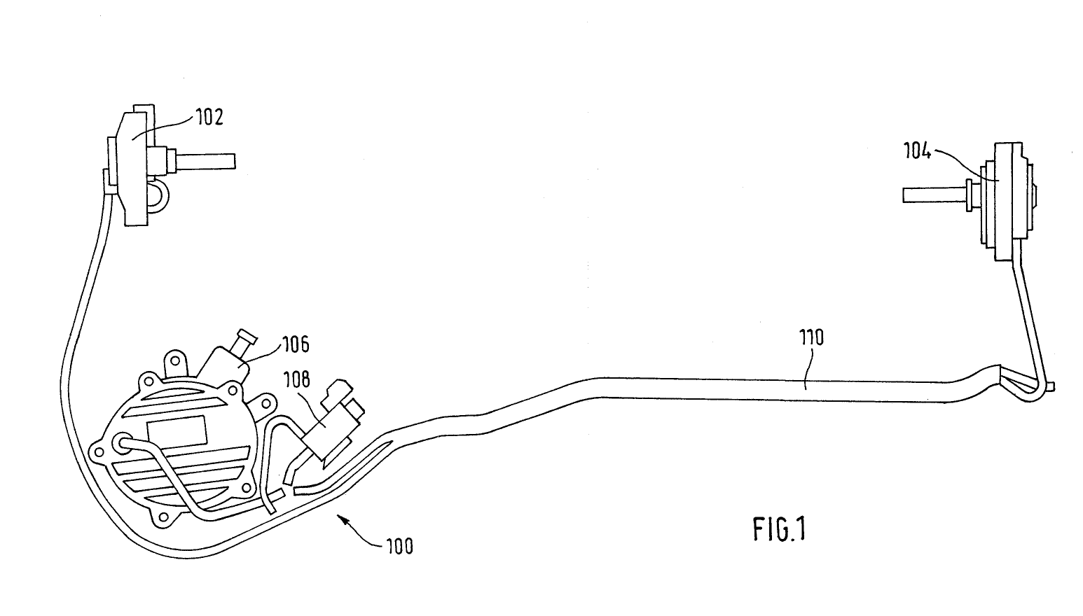

FIG. 1 shows a crankcase ventilation device 100 having shutoff valves 102, 104 actuated by partial vacuum, a partial vacuum pump 106, and an electric changeover valve 108. Such a crankcase ventilation device 100 is suitable for use in an internal combustion engine (not shown in greater detail here) having two cylinder groups, which each have a separate intake system, for example, a V-12 cylinder internal combustion engine. Crankcase ventilation gases are fed in at two points, in that the shutoff valve 102 is assigned to a first intake system and the shutoff valve 104 is assigned to a second intake system. According to other exemplary embodiments, the crankcase ventilation device may also include only one shutoff valve, for example, if crankcase ventilation gases are to be fed into the intake system at only one point, or may include more than two shutoff valves. Shutoff valves 102, 104, partial vacuum pump 106, and electric changeover valve 108 are connected to pressure lines 110.

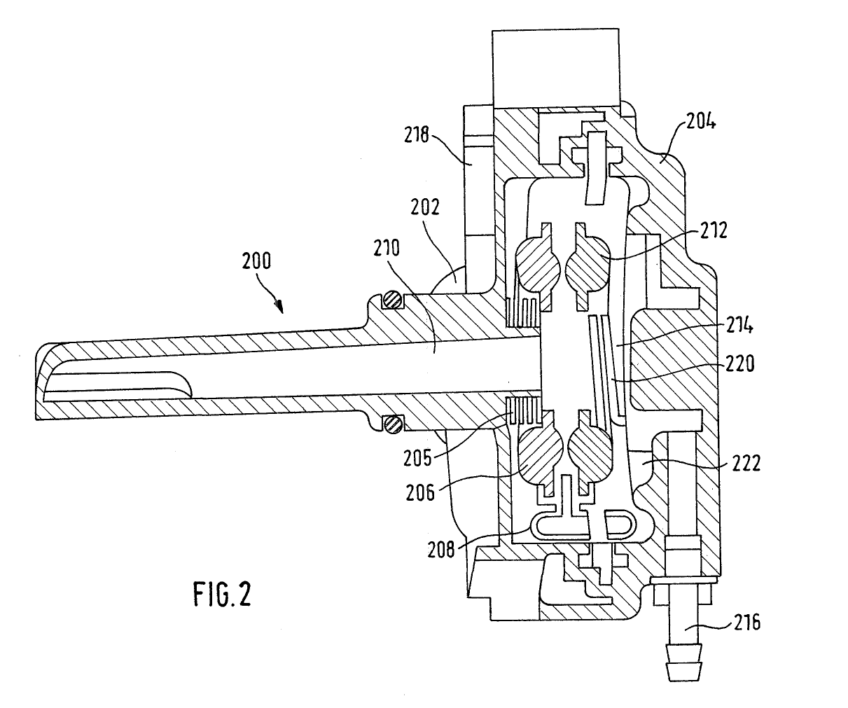

A shutoff valve 200, which may be actuated by partial vacuum, for a crankcase ventilator is shown in section in FIG. 2. An inlet connecting piece 202, which is partially concealed in the present view, is used to connect the shutoff valve 200 to a ventilation opening in the crankcase of the internal combustion engine. In the installed position, the shutoff valve 200 is fastened using an attachment flange 218 of the valve housing 204 to an intake system (not shown here) of the internal combustion engine. An outlet connecting piece 210 projects through an inlet opening in the intake system into the area of the intake system which conducts intake air. As a result, starting from the inlet connecting piece 202, via the chamber formed inside the valve housing 204 between valve housing 204 and a valve diaphragm 206, and the connecting piece 210, crankcase ventilation gases may be supplied to the intake system.

During operation of the internal combustion engine, a partial vacuum prevails in the intake system, while blow by gases act to increase the pressure in the crankcase. A predetermined partial vacuum may also be achieved in the crankcase in that the intake system is connected to the crankcase to conduct gas with the shutoff valve 200 interposed. The partial vacuum in the crankcase is regulated using the shutoff valve 200 having the valve diaphragm 206, which works together with the opening of the outlet connecting piece 210 on the shutoff valve side in the valve housing 204.

The valve diaphragm 206 is impinged upon by the force of a valve spring 205, which is supported on the housing side, in the opening direction. In the shutoff direction, the valve diaphragm 206 is impinged upon by the force of a shutoff spring 220 having a shutoff diaphragm 212 interposed, which is supported on the valve diaphragm 206 on one side and on the shutoff spring 220 on the other side. The force of the shutoff spring 220 exceeds the force of the valve spring 205 such that when the shutoff spring force is fully active, the shutoff valve 200 is blocked and remains securely closed even in the event of a partial vacuum in the crankcase and/or overpressure in the intake system.

A separate closed chamber 214, which is externally accessible and may be evacuated via an opening having connecting piece 216, is formed between shutoff membrane 212 and valve housing 204 inside the valve housing 204. If the chamber 214 is evacuated, the shutoff diaphragm is impinged by partial vacuum against the force of the valve spring 220 and the shutoff spring force acting on the valve diaphragm 206 is thus decreased. As soon as the force of the shutoff spring 220 acting via the shutoff membrane 212 on the valve diaphragm 206 is reduced by partial vacuum enough that it falls below the force of the valve spring 205—taking a possible overpressure or partial vacuum in the crankcase or in the intake system into consideration—the valve diaphragm 206 is displaced in the opening direction and releases (opens) the ventilation line between the intake system and the crankcase.

If the pressure-compensating connection between the intake system and the crankcase is open, a regulation of the crankcase pressure occurs as usual. In the event of lower pressure in the intake system than the pressure in the crankcase, the valve diaphragm 206 is displaced against the force of the valve spring 205 toward the valve seat and thus decreases the passage cross-section for crankcase ventilation gases. If the partial vacuum in the intake system becomes too great, the valve diaphragm 206 briefly closes the passage for crankcase ventilation gases.

An evacuation of the chamber 214 is performed using the partial vacuum pump 106, which is connected using pressure lines 110 to the shutoff valves 102, 104. The electric changeover valve 108 is provided to activate the partial vacuum pump 106. The partial vacuum pump 106 is turned on if opening the crankcase ventilator is harmless in regard to safety, otherwise—in critical phases, in particular during the startup and during shutdown of the internal combustion engine—the partial vacuum pump 106 is turned off and the crankcase ventilator is thus blocked.

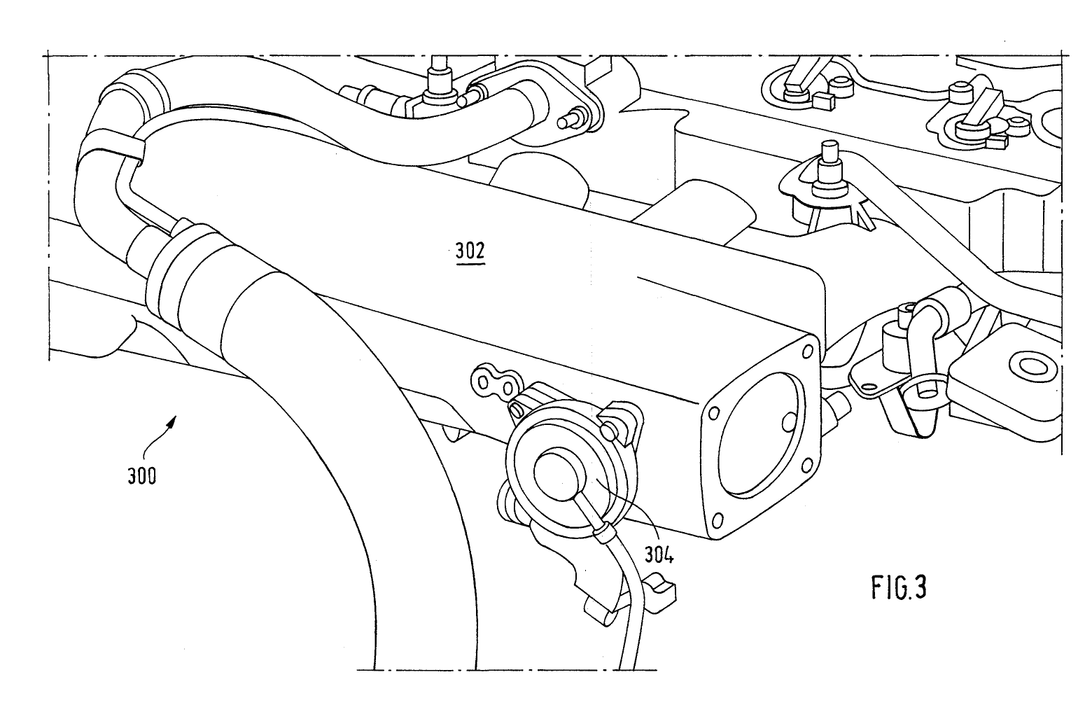

FIG. 3 shows an intake system 302 of a hydrogen-operated V-12 cylinder internal combustion engine 300 having a shutoff valve 304, which is actuated by partial vacuum, in the installed position.

In gas-operated, in particular hydrogen-operated internal combustion engines, damage of the internal combustion engine by flashbacks into the crankcase is avoided by the present invention. In addition, the hydrogen quantities which may flow into the intake system after the internal combustion engine is turned off are reduced. The effects in the event of a flashback into the crankcase are thus decreased.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A pressure control valve for a crankcase ventilator of an internal combustion engine, comprising:
a valve housing;
a valve diaphragm;
a valve spring; and
a separate shutoff valve operatively configured to shut off the pressure control valve.

2. The pressure control valve according to claim 1, wherein the separate shutoff valve blocks the pressure control valve in a non-actuated preferential position, and releases the pressure control valve in an actuated position.

3. The pressure control valve according to claim 1, wherein the separate shutoff valve comprises a shutoff diaphragm and a shutoff spring, and wherein the shutoff diaphragm operates in conjunction with the valve diaphragm to shutoff the pressure control valve.

4. The pressure control valve according to claim 2, wherein the separate shutoff valve comprises a shutoff diaphragm and a shutoff spring, and wherein the shutoff diaphragm operates in conjunction with the valve diaphragm to shutoff the pressure control valve.

5. The pressure control valve according to claim 3, wherein the shutoff valve is arranged in the valve housing, a separate chamber being formed between shutoff diaphragm and the valve housing.

6. The pressure control valve according to claim 4, wherein the shutoff valve is arranged in the valve housing, a separate chamber being formed between shutoff diaphragm and the valve housing.

7. The pressure control valve according to claim 5, wherein the separate chamber may be evacuated.

8. A crankcase ventilation device of an internal combustion engine, comprising:
a pressure control valve including a valve housing, a valve diaphragm, a valve spring, and a separate shutoff valve operatively configured to shut off the pressure control valve, wherein the separate shutoff valve blocks the pressure control valve in a non-actuated preferential position, and releases the pressure control valve in an actuated position;
wherein the separate shutoff valve comprises a shutoff diaphragm and a shutoff spring, the shutoff diaphragm operating in conjunction with the valve diaphragm to shutoff the pressure control valve, and wherein the shutoff valve is arranged in the valve housing, a separate chamber being formed between shutoff diaphragm and the valve housing; and
a partial vacuum pump operatively arranged for evacuating the separate chamber.

9. The crankcase ventilation device according to claim 8, further comprising:
an electric changeover valve, which is powerable, for switching the partial vacuum pump, the separate chamber not being evacuated if the electric changeover valve is not powered and the separate chamber being evacuated if the electric changeover valve is powered.

10. The crankcase ventilation device according to claim 8, further comprising at least one additional pressure control valve, wherein the partial vacuum pump is a shared partial vacuum pump for evacuating the separate chambers of the pressure control valves.

11. The crankcase ventilation device according to claim 9, further comprising at least one additional pressure control valve, wherein the partial vacuum pump is a shared partial vacuum pump for evacuating the separate chambers of the pressure control valves.

12. A method for operating an internal combustion engine having a crankcase ventilation device including a pressure control valve having a valve housing, a valve diaphragm, a valve spring, and a separate shutoff valve operatively configured to shut off the pressure control valve, wherein the shutoff valve blocks the pressure control valve in a non-actuated preferential position, and releases the pressure control valve in an actuated position, the method comprising the acts of:
determining if a flashover of a combustible mixture is to be prevented in a crankcase of the internal combustion engine; and
closing the pressure control valve to prevent the flashover of the combustible mixture in the crankcase.

13. The method according to claim 12, wherein the determining act corresponds to a turning-off of the internal combustion engine, wherein the pressure control valve is closed when the internal combustion engine is turned off.

14. The method according to claim 12, wherein the determining act corresponds to a starting phase of the internal combustion engine, wherein the pressure control valve is closed during the starting phase of the internal combustion engine.

15. The method according to claim 13, wherein the determining act corresponds to a starting phase of the internal combustion engine, wherein the pressure control valve is closed during the starting phase of the internal combustion engine.
